(19) United States
(12) Patent Application Publication
(10) Pub. No.: US 2003/0160826 A1
(43) Pub. Date: Aug. 28, 2003

(54) Method, apparatus and computer product to organize data on a display and facilitate testing of an integrated circuit design

(75) Inventors: Trung M. Tran, Round Rock, TX (US); Alan C. Folta, Austin, TX (US)

Correspondence Address: ZAGORIN O'BRIEN & GRAHAM LLP, 401 W 15TH STREET, SUITE 870, AUSTIN, TX, 78701, US

(73) Assignee: SUN MICROSYSTEMS, INC., Palo Alto, CA (US)

(21) Appl. No.: 10/083,229

(22) Filed: Feb. 26, 2002

(51) Int. Cl. G09G 5/00

(52) U.S. Cl. 345/771; 345/840

(57) ABSTRACT

Provided is a method, apparatus and computer product to organize data on a display to facilitate testing of an integrated circuit design of an integrated circuit undergoing development. The invention includes segmenting the display into a plurality of regions. Displayed in a first of the plurality of regions is information associated with a netlist that is stored on the server. The information includes a plurality of cell names displayed on the client terminal that correspond to a plurality of electrical functions included in the integrated circuit design. In a second of the plurality of regions, a plurality of virtual buttons is displayed. A subset of the virtual buttons operates to cause the client terminal/server to test the electrical functions, of the integrated circuit design, that are associated with the test group.

### BACKGROUND OF THE INVENTION

The present invention relates to integrated circuit development, and more specifically to testing of integrated circuit designs over a computer network.

Computer networks have facilitated collaborative efforts of several individuals remotely disposed from one another. Typically, a computer network includes a plurality of users employing client computers communicating with a remote server computer to transfer data therebetween. To facilitate data transfer between the server and the client computers, employed is one or more of several protocols, such as the standardized Hypertext Transfer Protocol (HTTP) for wide area networking environments or the Ethernet protocol for communicating over local area networking environments.

Communication between the server and the client terminal is achieved through software executed on the client terminal that creates an interface. Most commonly the interface is graphics driven, thereby providing the user with a graphical user interface (GUI)-based communication with data obtained from a server.

A GUI displays information that includes selectable elements, such as file selection links and virtual buttons, on a display device for a user to view and select. When a selectable element is selected the underlying computer based application responds by providing information and performing certain operations. In most cases, the burden is upon the user to determine which selectable element will perform the necessary functions and achieve the desired results.

Organizing the selectable elements on a GUI in a logical manner can help a user determine the selectable element that should be chosen. Typically, the most frequently used selectable elements are located in an area of the GUI a user can efficiently access. This arrangement reduces the amount of time a user must search for a selectable element capable of performing a particular function. The additional time provided by organizing selectable elements on a GUI can be used to process additional information and perform more tasks.

For example, in the complex environment of circuit development proper arrangement of information on the GUI can prove beneficial. An overview of a typical design process for integrated circuits is shown in the flow diagram of FIG. 1. The process can be generally divided into a front-end design phase and a back-end development phase. During the front-end phase, the engineer user designs and develops, from a set of specifications, a logical representation of the integrated circuit of interest in the form of a schematic, at step 10. The schematic is then entered on the server from which a circuit netlist is generated, at step 12. The netlist defines the entire integrated circuit, including all components and interconnections. Alternatively, the integrated circuit information may be developed using hardware description language (HDL) and synthesis. With the aid of integrated circuit test tools available to the client terminal from the server, the user then tests the design of the integrated circuit, at step 14. For example, the operation of the integrated circuit design may be emulated. The integrated circuit design test process may involve several iterations of design modifications and improvements until the integrated circuit design is finalized.

The back-end development involves several steps during which a final circuit layout (physical description) is developed based on the schematic. During placement step 16, various building blocks (or cells) as defined by the finalized integrated circuit schematic are placed within a predefined floor plan. For integrated circuit designs based on array or standard cell technology, the various circuit building blocks are typically predefined and made available to the client terminal from a cell library stored on the server. As a result, each cell may correspond to one or more electrical functions, e.g., resistor, capacitor, differential operational amplifier, J-K flip-flop and the like. Placement is followed by a routing step 18, during which interconnects between cells are routed throughout the layout. Finally, the accuracy of the layout versus the schematic is verified at step 20. To that end, the design rules are verified by calling a file on the server that tests the different aspects of the integrated circuit design against different design criteria. For example, the electrical performance of the electrical functions corresponding to the cells employed may be tested. Were no errors or design rule violations found, at step 22, the circuit layout information is used for the process of fabrication at step 24.

The amount of information required to test integrated circuit designs may be enormous. For example, several dozen cells may be required to verify the electrical performance of the integrated circuit design, referred to as design verification.

A need exists, therefore, to provide a method, and apparatus and a computer product, such as a GUI, to facilitate integrated circuit design over a computer network and assist a user with monitoring cell data employed to test an integrated circuit design.

### SUMMARY OF THE INVENTION

The present invention provides a method, apparatus and computer product to organize data on a display to facilitate testing of integrated circuit designs using a computer network that includes a server and a client terminal. One embodiment of the invention includes segmenting the display into a plurality of regions. Displayed in a first of the plurality of regions is information associated with a netlist that is stored on the server. The information includes a plurality of cell names displayed on the client terminal that correspond to a plurality of electrical functions included in the integrated circuit. In a second of the plurality of regions, a plurality of virtual buttons is displayed. A subset of the virtual buttons operates to cause the client terminal/the server to test the design of the electrical functions associated with a group of the plurality of cell names, referred to as the test group.

The cell names affiliated with the test group are identified in various manners to distinguish them from the remaining cell names. For example, the cell names may be listed in a different font, font color, or background color. Additionally, a flag may be disposed adjacent to the cell names affiliated with the test group.

The virtual buttons facilitate testing of the electrical functions of the integrated circuit design that are associated with the cell names by configuring the test group employing differing selection criteria. For example, one of the virtual buttons may be employed to selectively choose the cell names to be included in the test group, individually. Another virtual button may be employed to affiliate cell names with the test group that corresponds to a range of addresses in the listing sequence. Yet another virtual button may be employed to select all cell names in the listing sequence to be affiliated with the test group. These and other embodiments are disclosed in more detail below.

### BRIEF DESCRIPTION OF THE DRAWINGS

FIG. 1 is a flow diagram of a process for designing integrated circuits in accordance with the prior art;

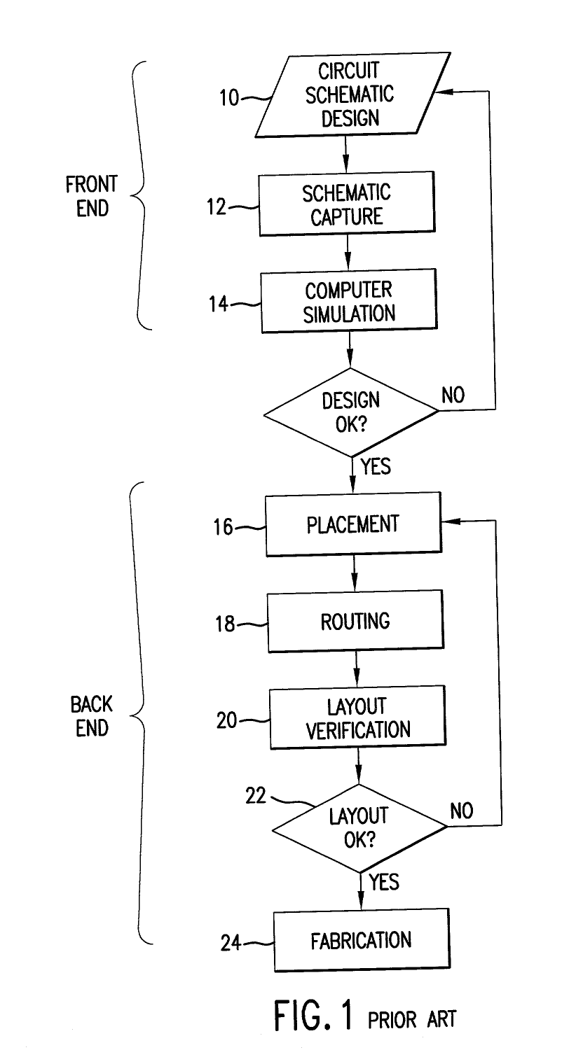

FIG. 2 is a simplified plan view of a computer network in which the present invention is implemented;

FIG. 3 is a block diagram of a client terminal shown in FIG. 2;

FIG. 4 is a plan view of a graphical user interface (GUI) employed on the client terminal shown in FIG. 3, in accordance with the present invention;

FIG. 5 is a plan view of a dialog box associated with the GUI shown in FIG. 4;

FIG. 6 is a plan view of an additional dialog box associated with the GUI shown in FIG. 4;

FIG. 7 is a plan view of a graphical user interface (GUI) in accordance with an alternate embodiment of the present invention; and

FIG. 8 is a plan view of a dialog box associated with the GUI shown in FIG. 7.

### DETAILED DESCRIPTION OF THE PREFERRED EMBODIMENTS

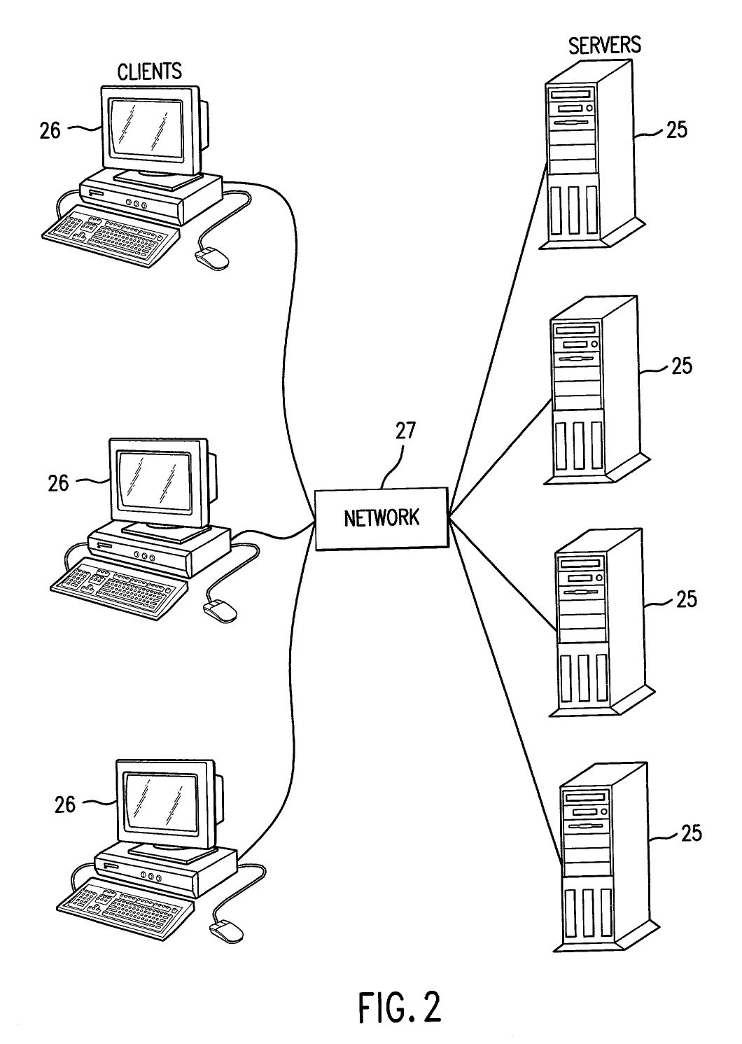

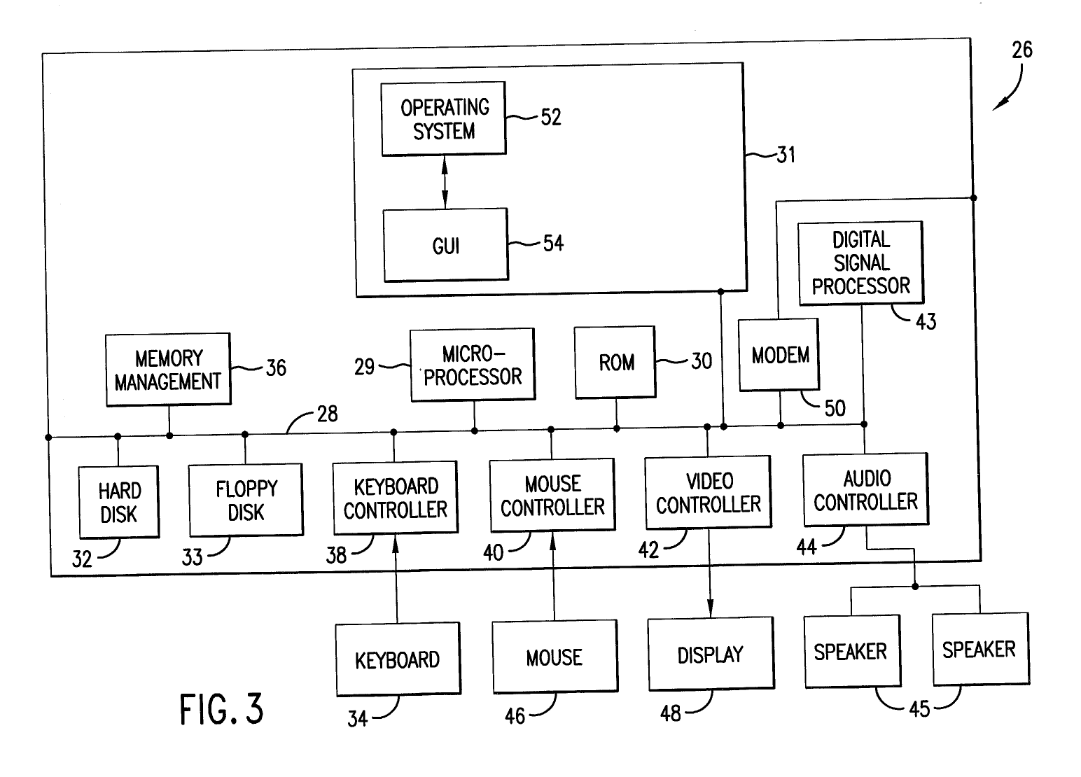

Referring to FIG. 2, shown is a plurality of servers 25 accessible by client terminals 26 over a network 27. Communication between servers 25 and client terminals 26 may be over a public network, such as a public switched telephone network over ASDL telephone lines or large bandwidth trunks, such as T1 or OC3 service. Alternatively, client terminals 26 may communicate with servers 25 over a local area network. In the present example, the invention is discussed with respect to communication over a network employing Ethernet protocols. To facilitate communication over network 27, client terminals 26 execute application specific software, to produce a Graphical User Interface (GUI), shown more clearly in FIG. 3.

Referring to FIG. 3, each of the client terminals 26 includes one or more system buses 28 placing various components thereof in data communication. For example, a microprocessor 29 is placed in data communication with both a read only memory (ROM) 30 and random access memory (RAM) 31 via system bus 28. ROM 30 contains among other code, the Basic Input-Output system (BIOS) that controls basic hardware operation such as the interaction with peripheral components such as disk drives 32 and 33, as well as the keyboard 34.

RAM 31 is the main memory into which the operating system and application programs are loaded and affords at least 32 megabytes of memory space. A memory management chip 36 is in data communication with system bus 28 to control direct memory access (DMA) operations. DMA operations include passing data between the RAM 31 and the hard disk drive 32 and the floppy disk drive 33.

Also in data communication with system bus 28 are various I/O controllers: a keyboard controller 38, a mouse controller 40, a video controller 42, and an audio controller 44, which may be connected to one or more speakers 45. Keyboard controller 38 provides a hardware interface for keyboard 34, and mouse controller 40 provides a hardware interface for a mouse 46, or other point and click device. Video controller 42 provides a hardware interface for a display 48. A Network Interface Card (NIC) 50 enables data communication over the network facilitating data transmission speeds up to 1000 megabytes per second. The operating system 52 of the client terminal 26 may be UNIX, LINUX, DOS, WINDOWS-based or any known operating system.

Referring to FIGS. 2, 3 and 4, GUI 54 is loaded in RAM 31 to facilitate circuit development over network 27 by segmenting display 48 into a plurality of regions, typically referred to as frames. Four regions are shown as 60, 62, 64 and 66; however, any number of regions may be included, depending upon the application. Region 60 displays a list of cell names, region 62 displays a plurality of data entry fields 62a, 62b, 62c, 62d and 62e, as well as a virtual button 62f. Region 64 includes a plurality of virtual buttons 68, 70, 72, 74, 76, 78 and 80. Region 66 is a textual display area, discussed more fully below.

To commence communication between client terminal 26 and server 25, referred to as a session, a user logs-in. Log-in is achieved by a user entering the appropriate information in data entry fields 62a, 62b, 62c, 62d and 62e. Then virtual button 62f is activated by effectuating a cursor event with respect thereto. To effectuate a cursor event, as is well known in the computer art, a cursor (not shown) on display 48 superimposes virtual button 62f, and a button (not shown) on mouse 46 is activated once or twice.

An exemplary log-in consists of a user entering the user's identity in data entry field 62a. One of servers 25 with which the user would like to communicate during the session is identified in data entry field 62b. A directory on server 25, identified in data entry field 62b, is recited in data entry field 62c. The particular project containing the integrated circuit design to test is identified in data entry field 62d. In this manner, region 62 functions as a log-in screen to allow a user access to the information necessary to test the integrated circuit design of interest. To restrict access, password data entry field 62e is provided in which any series of number or letters may be entered. As is standard with most password security features, password data is never recited in the field 62e.

After the requisite information has been entered into data entry fields 62a, 62b, 62c, 62d and 62e, virtual button 62f is activated. In response, data entered in fields 62a, 62b, 62c, 62d and 62e is submitted to server 25. Alternatively, virtual button 62f may be omitted and the aforementioned information submitted by depressing an enter key (not shown) on keyboard 34. Server 25 responds by transmitting information corresponding to a netlist to the client terminal 26. GUI 54 interprets the information and forms a visual representation of the cell names included in the netlist using local resources, e.g., fonts and colors, which are recited as a plurality of cell names 60a-1 in region 60. Each of the cell names corresponds to one or more electrical functions, e.g., a resistor, a capacitor, differential operational amplifier, J-K flip-flop and the like that is included in the integrated circuit design undergoing test. Cell names 60a-1 are recited in a predetermined sequence, e.g., alphabetically, or numerically and the like. In this manner, the user may easily locate the cell name of interest. Were region 60 of insufficient size to display all cell names concurrently, then a scroll bar 60m would be present on one side of region 60 as is known in the art, to facilitate displaying additional cell names in the sequence.

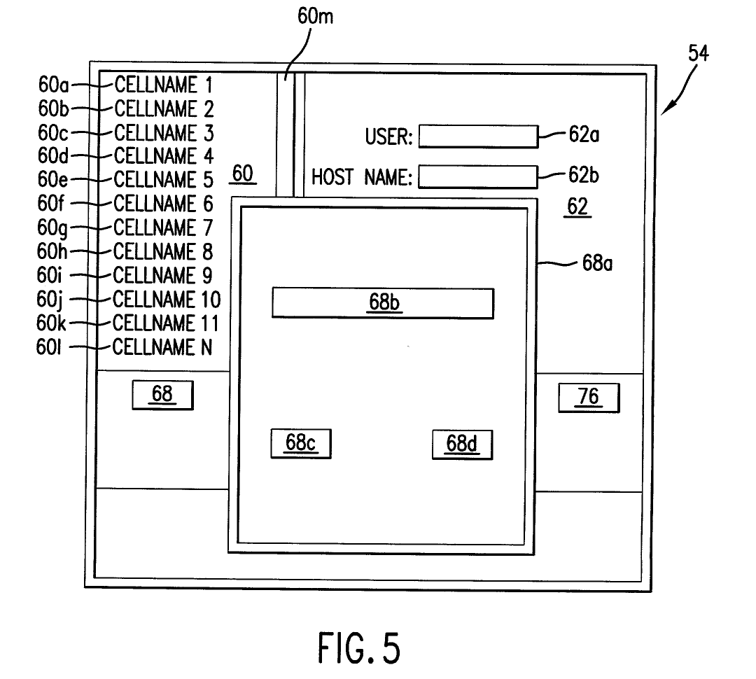

Referring to FIGS. 2, 4 and 5, were a user to desire to test the integrated circuit design, the user selects a group of the cell names 60a-l corresponding to the appropriate electrical functions associated with the integrated circuit design, defining a test group. A subgroup of virtual buttons 68, 70, 72, 74, 76, 78 and 80 facilitate selecting differing groups of cell names 60a-l using differing criteria.

For example, virtual button 68 allows selectively associating individual cell names with the test group. To that end, each of the cell names 60a-1 correspond to an address 61 in the sequence that differs from the address 61 corresponding to the remaining cell names of the sequence. Effectuating a cursor event with respect to virtual button 68 opens a dialog box 68a having a data entry field 68b and virtual button 68c and 68d. To associate the cell names 60a-1 recited in region 60 with the test group, the individual address of the cell names are entered into the data entry field 68b. Each address may be separated by a space, comma or any other suitable identifier to distinguish between addresses in the string of addresses entered into data entry field 68b.

After the addresses are entered into data entry field 68b, the corresponding cell name in region 60 may be identified as being included in the test group. This may be via changing the font, font color, background of region 60 surrounding the corresponding cell name or simply placing an icon adjacent thereto, such as a flag, 63. In this manner, a visually perceivable identifier may be associated with the cell name corresponding to the address entered into data entry field 68b. The advantages of this are manifold. For example, each integrated circuit design may include dozens of cell names in order to test the integrated circuit design. With the present GUI 54, the cell names need not be entered into the GUI 54. Considering that the cell names are often complex and lengthy, typographical errors are avoided by abrogating the need of having a user enter this information. In addition, reciting all available cell names in region 60 abrogates the need to refer to separate documentation to properly recollect all of the cell names available for testing. In this manner, the time required to test an integrated circuit design is reduced.

In addition, demarking the cell names 60a-1 recited in region 60 that are affiliated with the test group facilitates a visual check by the user to ensure that the desired cell names are included, before actually undertaking integrated circuit design testing. After the requisite cell names are affiliated with the test group, either virtual button 68c or 68d is activated. Activating virtual button 68c causes dialog box 68a to vanish and commences testing of parameters of the electrical functions associated with the test group in a test sequence that matches the sequence in which the cell names 60a-l are recited in region 60.

Parameters that are tested may include a design rule check “drc”, an electrical rule check “erc”, a routing check “lvs” and a power check, “power”. A “drc” tests the electrical functions of the integrated circuit design that are associated with the test group to determine whether appropriate design rules are satisfied. Examples of design rules may include minimum distance between active and passive components associated with the electrical functions of the test group. An “erc” tests the electrical functions of the integrated circuit design that are associated with the test group to ensure that the appropriate electrical rules are satisfied, e.g., the electrical operation of the electrical functions. An “lvs” tests the layout of the integrated circuit design to determine whether appropriate routing rules are satisfied, e.g., that the minimum or maximum length of the interconnect lines comply with the routing rules. A “power” check tests the electrical functions of the integrated circuit design that are associated with the test group to determine whether appropriate power rules are satisfied, e.g., whether too much current is drawn by the electrical functions associated with the test group.

Activating virtual button 68d causes dialog box 68a to vanish and establishes the testing of the electrical functions, of the integrated circuit design, that are associated with the test group. These electrical functions are tested in a test sequence independent of the sequence in which the cell names corresponding to the electrical functions are recited in region 60.

To initiate a test of the integrated circuit design, virtual button 78 is activated. In response, an option file (not shown), which includes information that defines the interrelationship between the electrical functions corresponding to the cell names in the test group, is called on client terminal 26 to commence testing. The results of the test of the integrated circuit design are displayed in region 66 as text messages, e.g., tested design matches the desired performance criteria, or the tested design does not meet performance criteria and the like.

For large test groups, e.g., test groups in which a large number of cell names are affiliated, it may be desired to execute the test employing server 25, presuming server 25 has much more computational power than client terminal 26. To that end, virtual button 80 is activated, instead of virtual button 78. Activation of virtual button 80 calls the option file (not shown) on server 25.

Allowing testing of individual electrical functions in the same order that the corresponding cell names are recited in region 60 allows a user to easily track integrated circuit design tests. However, a drawback with respect to this testing technique is that the server 25 is shared among multiple users. The server 25 may be requested to test the same electrical function for a common integrated circuit design concurrently; but, server 25 cannot perform this task simultaneously for multiple users. As a result, server 25 would queue the requests and require one or more users to wait for resources of server 25 to test an integrated circuit design, thereby possibly increasing the testing time for multiple users. To avoid this situation, activation of virtual button 68d allows testing of electrical functions of the integrated circuit design independent of the listing sequence, once a test is commenced by activation of virtual button 80. However, virtual button 68d may be employed when integrated circuit design testing is performed on client terminal 26 by activation of virtual button 78, as well.

Typically, the test sequence is dictated by resource availability afforded by client terminal 26 or server 25 when button 68d is activated, depending upon which system performs the integrated circuit design test. For example, the test sequence is randomized by server 25 sequentially calling test routines for each electrical function associated with cell names affiliated with the test group in the order in which the cell names are listed in region 60. Were the resource unavailable to server 25 to test any given electrical function at a given time, server 25 would tag the cell name associated with the electrical function and proceed to the next electrical function associated with the cell name recited next in the group. After attempting to test all electrical functions in the test group, server 25 assesses the presence of any tagged cell names. Were any cell names tagged, server 25 would return to test electrical functions associated with the tagged cell names.

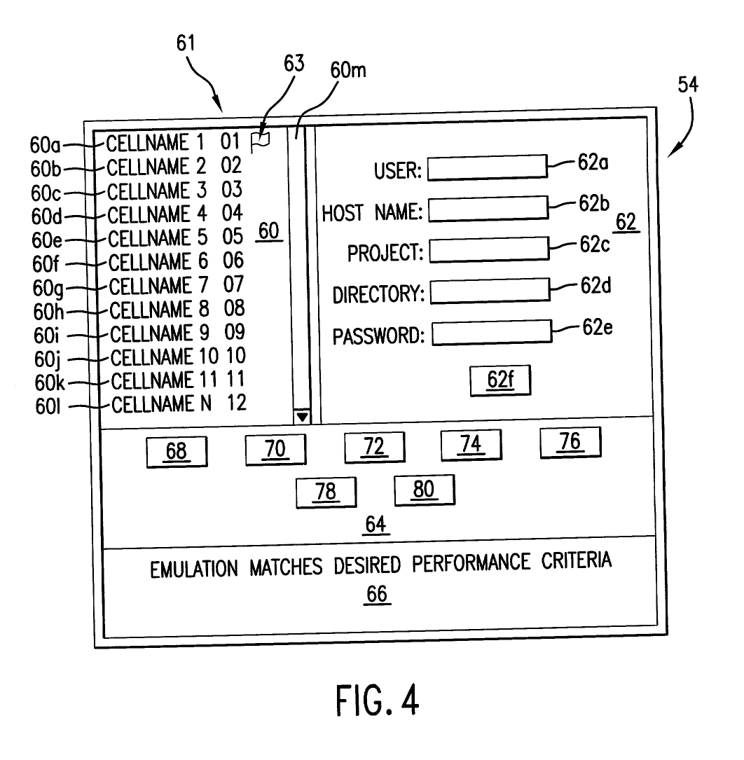

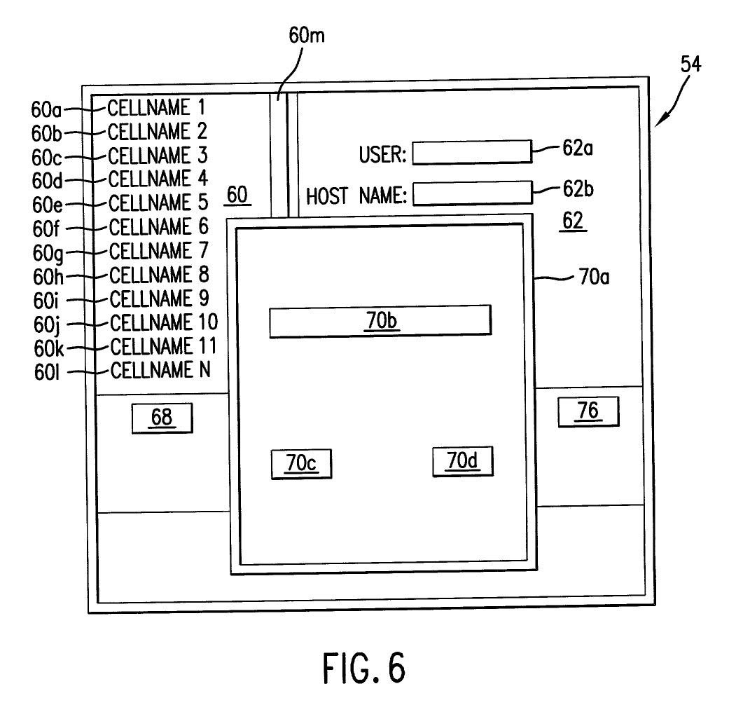

Referring to FIGS. 4, 5 and 6, virtual button 70 may be employed to select blocks of cell names 60a-l affiliated with the test group. To that end, activating virtual button 70 opens dialog box 70a that includes a data entry field 70b and virtual buttons 70c and 70d. Cell names affiliated with the test group are entered into data entry field 70b as a range of addresses that correspond to the cell names 60a-l affiliated with test group. For example, to include cell names 60a-d, address range 01-04 is entered into data entry field 70b. This further reduces the amount of information that must be entered into GUI 54 by a user in order to test an integrated circuit design. Effectuating a cursor event with respect to virtual button 70c causes dialog box 70a to vanish and commences testing of the electrical functions, of the integrated circuit design, that are associated with the test group in a test sequence that matches the sequence in which the cell names are recited in region 60. Effectuating a cursor event with respect to virtual button 70d causes dialog box 70a to vanish and commences testing of the electrical functions, of the integrated circuit design, that are associated with the test group in a test sequence that is independent of the sequence in which the cell names are recited in region 60.

To increase the information provided in region 60, the cell names identified in data entry box 70b may be demarked with a visual representation that differs from the visual representation associated with the cell names entered into data entry region 68b. In this manner should it be desired to edit cell names affiliated with the test group, then the user would readily know which of the two dialog boxes, 68a or 70a, to open in order to effectuate a change. To add further versatility to the information provided in region 60, were the same cell name entered twice, for example as an individual cell name in data entry field 68b, and as part of a range of addresses in dialog box 70a, then a unique demarcation may be shown with respect to the cell name corresponding to the dual entry in region 60. For example, the dual entry cell name could be displayed with a flashing red font indicating an error.

Referring to FIG. 4, further utility is provided with virtual button 72 which may function as a “select all” grouping. As a result, effectuating a cursor event with respect to virtual button 72 would result in affiliation of all cell names 60a-l recited in region 60 with the test group. Virtual button 74 could operate as a clear function. Effectuating a cursor event with respect to virtual button 74 would deselect all cell names from the test group and remove all messages from region 66. Finally, virtual button 76 would operate to terminate the session and log-out the user.

Alternatively, to further reduce user machinations involved with manipulating information on GUI 54, dialog boxes 68a and 70a may be abrogated. To that end, selection of cell names into the test group is achieved by superimposing a cursor (not shown) on one or more of the cell names and effectuating a cursor event with respect thereto. As a result of effectuating the cursor event, the cell names are identified as being affiliated with the test group in various manners. For example the cell names may be displayed in a different font, font color, background color, or having a flag disposed adjacent thereto.

Multiple cell names may be affiliated with the test group. However, the actual cell names affiliated with the test group are defined by the virtual button 68, 70, 72, 74, 76 or 80 that is activated. For example, were cell name 2 and cell name 8 subjected to a cursor event, activation of virtual button 68 causes testing of the electrical functions, of the integrated circuit design, that are associated with cell names 2 and 8. However, were the same cell names affiliated with the test group and virtual button 70 activated then all cell names from cell name 2 to cell name 8, i.e. cell names 28, would be affiliated with the test group. In this manner, virtual button 70 interprets the affiliation of cell names 2 and 8 in the test group as defining a range of addresses corresponding to cell names to be affiliated with the test group. The range of cell name addresses would consist of 02-08, inclusive.

Were a third cell name identified as being affiliated with the test group, e.g., cell name 6, then the affiliation of cell names 2, 6 and 8 would be interpreted, upon activation of virtual button 70, as a range of addresses corresponding to cell names to be affiliated with the test group. The range of cell name addresses would consist of 02-08, inclusive. Alternatively, activation of virtual button 70 would result in an interpretation of the affiliation of cell names 2, 6 and 8 with the test group as defining the range of cell names corresponding to addresses 02-06, inclusive. In yet another embodiment, activation of virtual button 70 would result in an interpretation of the affiliation of cell names 2, 6 and 8 with the test group as defining the range of cell names corresponding to addresses 06-08, inclusive.

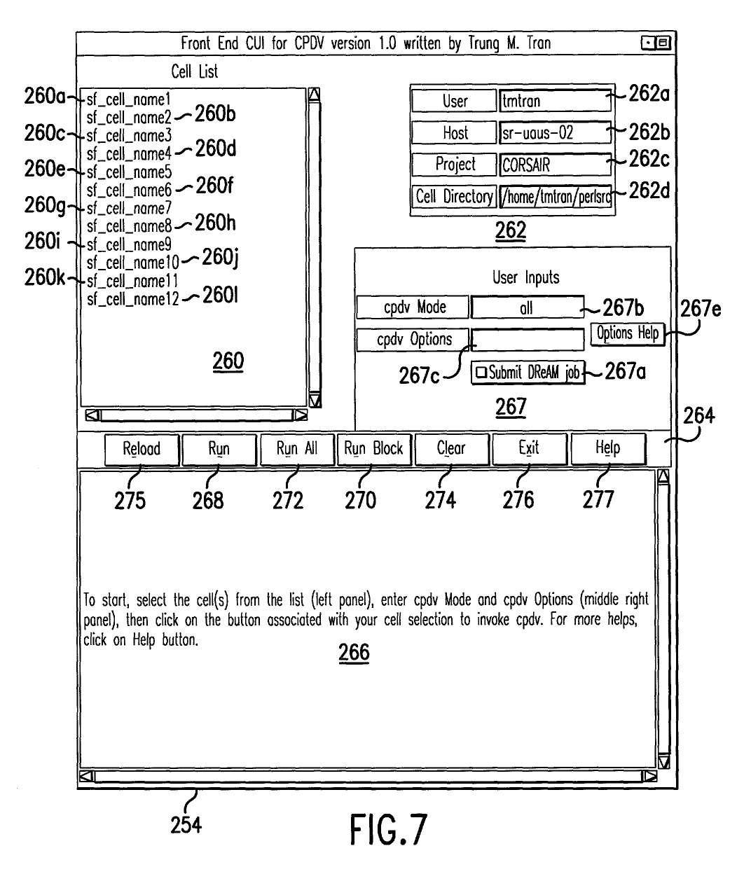

Referring to FIGS. 4 and 7, a second alternate embodiment of the present invention provides a GUI 254 that is segmented into five regions, 260, 262, 264, 266 and 267. Region 260 displays a list of cell names 260a-260l. Region 262 displays a plurality of data entry fields 262a, 262b, 262c and 262d. Data entry fields 262a, 262b, 262c and 262d function in the manner discussed above with respect to data entry fields 62a, 62b, 62c and 62d. Although not shown, a password data entry field, such as 62e, may be included in region 262.

Region 264 includes a plurality of virtual buttons 268, 270, 272, 274, 275, 276 and 277. Virtual buttons 274 and 276 operate in the manner described above with respect to virtual buttons 74 and 76. Virtual button 277 operates as a refresh function to reload the netlist from server 25 to client terminal 26. In this manner, were the netlist amended, the appropriate cell name information may be displayed in region 260. Virtual button 275 operates to display help information (not shown) in GUI 254 by calling a help file from either server 25 or client terminal 26, shown in FIG. 2.

Referring again to FIGS. 4 and 7, virtual buttons 268, 270 and 272 may operate to associate cell names with the test group in the manner discussed above with either embodiment described with respect to FIG. 4. For example, affiliation of cell names with the test group is achieved by superimposing a cursor (not shown) on one or more of the cell names 260a-2601 and effectuating a cursor event with respect thereto. As a result of effectuating the cursor event, the cell names are identified as being affiliated with the test group. However, the actual cell names affiliated with the test group is defined by virtual button 268, 270 or 274 that is activated.

Referring to FIGS. 2 and 7, by activation of one of virtual buttons 268, 270 or 274, the option file (not shown) is called from client terminal 26 and the integrated circuit design test is performed locally on client terminal 26. Were a user to desire to run the integrated circuit design test on server 25, then a virtual button 267a included in region 267 would be activated.

Specifically, as shown in FIG. 7, region 267 includes two virtual buttons 267a and 267b, as well as a data entry field 267c. Region 267 provides GUI 254 with added functionality. To that end, virtual button 267b, labeled as cpdv mode, facilitates tests differing design criteria of the integrated circuit design.

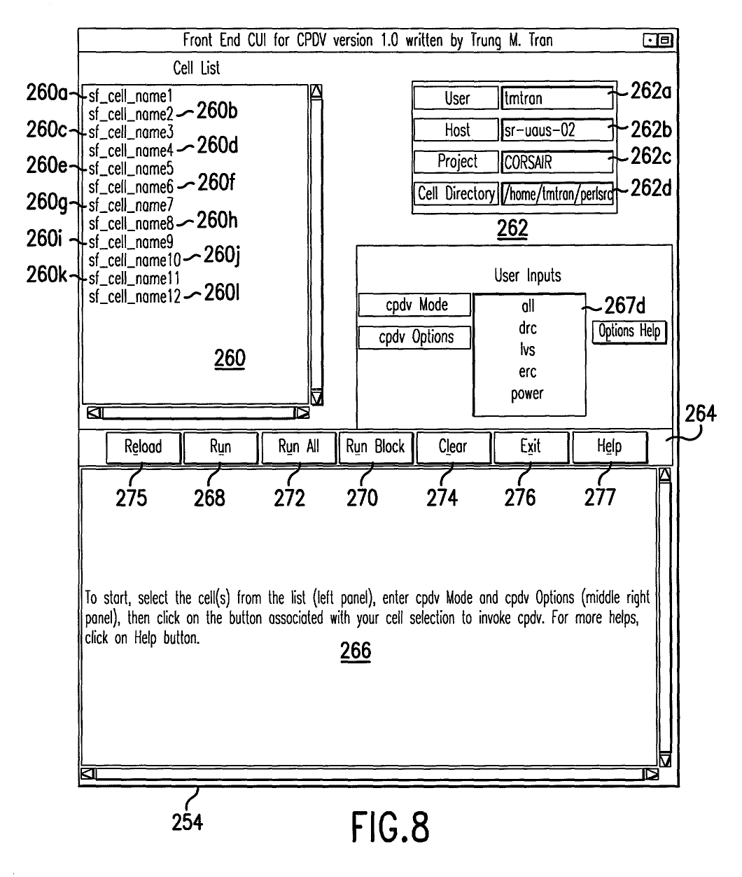

Referring to both FIGS. 7 and 8, activating virtual 267b button opens a pull-down menu 267d that recites a list of mode names shown as “all”, “drc”, “lvs”, “erc” and “power”. By superimposing a cursor (not shown) on one or more of the mode names and effectuating a cursor event, the user may evaluate differing design criteria for one or more of the electrical functions associated with the cell names. For example, selection of “drc” allows ascertaining the compliance of test group with the appropriate design rules. Selection of “lvs” allows ascertaining the compliance of the test group with the routing rules. Selection of “erc” allows ascertaining the compliance of the test group with the electrical rules. Selection of “power” allows ascertaining the compliance of the test group with the power constraints. Finally, selection of all allows testing for all of the aforementioned design criteria.

Referring again to FIG. 7, data entry field 267c provides additional functionality to GUI 254 by allowing a user to enter commands, such as save test results to a specific file, directory, server 25, client terminal 26 and the like. To assist with understanding the option capabilities afforded by GUI 254 virtual button 267e may be included. Once activated, a dial box (not shown) is displayed in GUI 254 explaining the option capabilities afforded by GUI 254.

Although the foregoing has been discussed with respect to integrated circuit design testing, it should be understood that the present invention may be employed in any type of computer aided design activity employing a graphical user interface. Also, other perceivable characteristics, in addition to the view parameters mentioned above, may be implemented to demark cell names. For example, an audible signal may be generated each time a cursor superimposes a cell name included in the test group. Thus, the embodiments of the present invention described above are exemplary and the scope of the invention should, therefore, be determined not with reference to the above description, but instead should be determined with reference to the appended claims along with their full scope of equivalents.

What is claimed is:

1. A computer implemented method for organizing data on a display to facilitate testing of an integrated circuit design having a plurality of electrical functions, said method comprising:
segmenting said display into a plurality of regions;
displaying, in a first of said plurality of regions, information associated with a netlist as a plurality of cell names, with said cell names being listed in a listing sequence and corresponding to said plurality of electrical functions;
displaying in a second of said plurality of regions, a plurality of virtual buttons, a subgroup of which operates to commence testing of parameters of a set of said plurality of electrical functions, with the electrical functions included in said set being associated with a group of said plurality of cell names; and
identifying, among said plurality of cell names, cell names affiliated with said group.

2. The method as recited in claim 1 further including selectively associating individual cell names with said group by effectuating a cursor event with respect to one of said plurality of virtual buttons and identifying among said plurality of cell names, cell names associated with said set of said plurality of said electrical functions.

3. The method as recited in claim 1 wherein each of said plurality of cell names corresponds to an address in said sequence that differs from the address corresponding to the remaining cell names in said sequence and further including affiliating cell names with said group by effectuating a cursor event with respect to one of said plurality of virtual buttons and identifying among said plurality of cell names, cell names that correspond to a range of addresses in said sequence associated with said set of said plurality of electrical functions.

4. The method as recited in claim 1 further including selectively affiliating all of said cell names with said group by effectuating a cursor event with respect to one of said plurality of virtual buttons and identifying all of said plurality of cell names.

5. The method as recited in claim 1 further including displaying a data entry field in a third of said plurality of regions to facilitate selecting, from multiple categories, a category of parameters of said set of said plurality of electrical functions to test.

6. The method as recited in claim 1 further including testing said parameters of said set of said plurality of electrical functions and displaying in a fourth of said plurality of regions information concerning results of said testing.

7. The method as recited in claim 1 further including sequentially testing said parameters of said set of said plurality of electrical functions, with an order in which the electrical functions of said set are tested being independent of an order in which said cell names are arranged in said listing sequence.

8. The method as recited in claim 1 wherein identifying said groups further includes displaying a visually perceivable identifier with said cell names.

9. The method as recited in claim 1 wherein identifying said groups further includes displaying a visually perceivable identifier with said cell name groups while maintaining said listing sequence.

10. A computer network to organize data on a display to facilitate testing of an integrated circuit design having a plurality of electrical functions, said network comprising:
a server storing a netlist;
a client terminal in data communication with said server, said client terminal having a display segmented into a plurality of regions, with information, associated with said netlist, being displayed in a first of said plurality of plurality of regions as a plurality of cell names, said cell names being ordered in a listing sequence and corresponding to a plurality of electrical functions, and a plurality of virtual buttons being displayed in a second of said plurality of regions, a subset of which operate to commence testing of parameters of a set of said plurality of electrical functions, the electrical functions included in said set being associated with a group of said plurality of cell names, said plurality of cell names affiliated with said group having a visually perceivable identifier associated therewith.

11. The network as recited in claim 10 wherein said visually perceivable identifier consists of having a region of said computer surrounding cell names, affiliated with said group, displayed in a color that differs from displayed in the region surrounding the remaining cell names of said plurality of cell names.

12. The network as recited in claim 10 wherein said visually perceivable identifier consists of an icon displayed adjacent to said cell names affiliated with said group.

13. The network as recited in claim 10 wherein said display further includes a data entry field displayed in a third of said plurality of regions to selectively allow access to said netlist.

14. The network as recited in claim 10 wherein said display further includes information concerning results of tests of said parameters of said set, with said information being displayed in a fourth of said plurality of regions.

15. A computer product having a computer readable medium that contains a program to control a server and a client terminal over a network said client terminal having a display to facilitate testing of an integrated circuit design having a plurality of electrical functions, said computer product comprising:
computer code to segment said display into a plurality of regions;
computer code to display, in a first of said plurality of regions, information associated with a netlist as a plurality of cell names, with said cell names being listed in a listing sequence and corresponding to said plurality of electrical functions;
computer code to display, in a second of said plurality of regions, a plurality of virtual buttons, a subgroup of which operates to commence testing of parameters of a set of said plurality of electrical functions, with the electrical functions included in said set being associated with a group of said plurality of cell names; and
computer code to identify, among said plurality of cell names associated with said group.

16. The computer product as recited in claim 15 further including computer code to selectively affiliate individual cell names with said group in response to a cursor event effectuated with respect to one of said plurality of virtual buttons.

17. The computer product as recited in claim 15 wherein said computer code to display in a first of said plurality of regions, information associated with a netlist further includes a first subroutine to affiliate each of said plurality of cell names corresponding to an address in said sequence that differs from the address corresponding to the remaining cell names in said sequence, and further including computer code to affiliate cell names with said group in response to a cursor event with respect to one of said plurality of virtual buttons, with said computer code to affiliate further including an additional subroutine to identify among said plurality of cell names, cell names that correspond to a range of addresses in said sequence associated with said set of said plurality of electrical functions.

18. The computer product as recited in claim 15 further including computer code to selectively affiliate all of said cell names with said group by effectuating a cursor event with respect to one of said plurality of virtual buttons.

19. The computer product as recited in claim 15 further including computer code to display, in a third of said plurality of regions, a data entry field to facilitate selecting, from multiple categories, a category of parameters of said set of said plurality of electrical functions to test.

20. The computer product as recited in claim 15 further including computer code to display, in a fourth of said plurality of regions, information concerning a test of said parameters.
